(19) United States
(12) Patent Application Publication
(10) Pub. No.: US 2020/0063248 A1
(43) Pub. Date: Feb. 27, 2020

(54) CAST STEEL ALLOY AND AUTOMOTIVE COMPONENTS FORMED THEREOF

(71) Applicant: GM GLOBAL TECHNOLOGY OPERATIONS LLC, Detroit, MI (US)

(72) Inventors: Jianghuai Yang, Rochester Hills, MI (US); Qigui Wang, Rochester Hills, MI (US); Daniel J. WILSON, Rochester Hills, MI (US); James D. Cremonesi, Waterford, MI (US); Paul J. Gelazin, Clarkston, MI (US)

(21) Appl. No.: 16/106,445

(22) Filed: Aug. 21, 2018

(51) Int. Cl. C22C 38/60; C22C 38/42; C22C 38/54; C22C 38/50; C22C 38/46; C22C 38/44; C22C 38/06; C22C 38/02; C22C 38/04; C22C 38/00

(52) U.S. Cl. CPC C22C 38/60; C22C 38/42; C22C 38/54; C22C 38/50; C22C 38/46; F16C 3/06; C22C 38/06; C22C 38/02; C22C 38/04; C22C 38/001; C22C 38/002; C22C 38/44

(57) ABSTRACT

A steel alloy and automotive components, such as crankshafts, produced therefrom are provided. The steel alloy includes iron, about 0.34 to about 0.40 weight percent carbon, about 0.8 to about 1.2 weight percent manganese, about 0.40 to about 0.60 weight percent silicon, about 0.04 to about 0.07 weight percent sulfur, about 0.9 to about 1.2 weight percent chromium, about 0.20 to about 0.35 weight percent molybdenum, about 0.08 to about 0.15 weight percent vanadium, and about 0.02 to about 0.06 weight percent aluminum. The steel alloy may also include up to 0.03 weight percent phosphorus, up to 0.25 weight percent nickel, up to 0.20 weight percent copper, up to 0.03 weight percent titanium, up to 0.03 weight percent nitrogen, and up to 0.002 weight percent boron.

### FIELD

The present disclosure relates generally to steel alloys, and more particularly, to steel alloys that have improved castability, as well as components made therefrom, such as crankshafts and transmission shafts.

### INTRODUCTION

Typical steel alloys are forged and then subjected to a quench and temper (QT) process. The conventional quench and temper (QT) process is used to refine grain size and increase base metal strength. The QT process involves rapid cooling from a heated state to put the metal into a hard state. This involves extra steps beyond the forging itself. Thus, casting of steel saves costs over what is required to harden a forged steel automotive component, but cast parts may have porosity issues.

### SUMMARY

This disclosure provides hard steel alloys that can be created by casting with little porosity without the need for the QT process after the forging step.

The disclosed steel alloy contains iron, carbon, manganese, silicon, sulfur, chromium, molybdenum, vanadium, and aluminum, and may also contain phosphorus, nickel, copper, titanium, nitrogen, and boron.

In one example, which may be combined with or separate from the other examples and features provided herein, a steel alloy is provided containing: iron, about 0.34 to about 0.40 weight percent carbon, about 0.8 to about 1.2 weight percent manganese, about 0.40 to about 0.60 weight percent silicon, about 0.04 to about 0.07 weight percent sulfur, about 0.9 to about 1.2 weight percent chromium, about 0.20 to about 0.35 weight percent molybdenum, about 0.08 to about 0.15 weight percent vanadium, and about 0.02 to about 0.06 weight percent aluminum.

In another example, which may be combined with or separate from the other examples and features provided herein, a cast automotive propulsion system component is provided that is formed of a steel alloy. The steel alloy comprises at least 95 weight percent iron, about 0.34 to about 0.40 weight percent carbon, about 0.40 to about 0.60 weight percent silicon, about 0.8 to about 1.2 weight percent manganese, about 0.04 to about 0.07 weight percent sulfur, about 0.9 to about 1.2 weight percent chromium, about 0.20 to about 0.35 weight percent molybdenum, about 0.08 to about 0.15 weight percent vanadium, and about 0.02 to about 0.06 weight percent aluminum. The steel alloy may also, optionally, contain one or more of the following: phosphorus in an amount not exceeding 0.03 weight percent, nickel in an amount not exceeding 0.25 weight percent, copper in an amount not exceeding 0.20 weight percent, titanium in an amount not exceeding 0.03 weight percent, nitrogen in an amount not exceeding 0.03 weight percent, and boron in an amount not exceeding 0.002 weight percent.

In yet another example, which may be combined with or separate from the other examples and features provided herein, a steel alloy is provided that consists essentially of: about 0.34 to about 0.40 weight percent carbon, about 0.40 to about 0.60 weight percent silicon, about 0.8 to about 1.2 weight percent manganese, about 0.04 to about 0.07 weight percent sulfur, about 0.9 to about 1.2 weight percent chromium, about 0.20 to about 0.35 weight percent molybdenum, about 0.08 to about 0.15 weight percent vanadium, about 0.02 to about 0.06 weight percent aluminum, a maximum of 0.03 weight percent phosphorus, a maximum of 0.25 weight percent nickel, a maximum of 0.20 weight percent copper, a maximum of 0.03 weight percent titanium, a maximum of 0.03 weight percent nitrogen, a maximum of 0.002 weight percent boron, and the balance iron.

In still another example, which may be combined with or separate from the other examples and features provided herein, a steel alloy is provided containing, at least: iron, 0.34 to 0.40 weight percent carbon, 0.8 to 1.2 weight percent manganese, 0.40 to 0.60 weight percent silicon, 0.04 to 0.07 weight percent sulfur, 0.9 to 1.2 weight percent chromium, 0.20 to 0.35 weight percent molybdenum, 0.08 to 0.15 weight percent vanadium, and 0.02 to 0.06 weight percent aluminum.

In still another example, which may be combined with or separate from the other examples and features provided herein, a cast automotive propulsion system component is provided that is formed of a steel alloy. The steel alloy comprises at least 95 weight percent iron, 0.34 to 0.40 weight percent carbon, 0.40 to 0.60 weight percent silicon, 0.8 to 1.2 weight percent manganese, 0.04 to 0.07 weight percent sulfur, 0.9 to 1.2 weight percent chromium, 0.20 to 0.35 weight percent molybdenum, 0.08 to 0.15 weight percent vanadium, 0.02 to 0.06 weight percent aluminum. The steel alloy may also contain one or more of the following: phosphorus in an amount not exceeding 0.03 weight percent, nickel in an amount not exceeding 0.25 weight percent, copper in an amount not exceeding 0.20 weight percent, titanium in an amount not exceeding 0.03 weight percent, nitrogen in an amount not exceeding 0.03 weight percent, and boron in an amount not exceeding 0.002 weight percent.

In still another example, which may be combined with or separate from the other examples and features provided herein, a steel alloy is provided that consists essentially of: 0.34 to 0.40 weight percent carbon, 0.40 to 0.60 weight percent silicon, 0.8 to 1.2 weight percent manganese, 0.04 to 0.07 weight percent sulfur, 0.9 to 1.2 weight percent chromium, 0.20 to 0.35 weight percent molybdenum, 0.08 to 0.15 weight percent vanadium, 0.02 to 0.06 weight percent aluminum, a maximum of 0.03 weight percent phosphorus, a maximum of 0.25 weight percent nickel, a maximum of 0.20 weight percent copper, a maximum of 0.03 weight percent titanium, a maximum of 0.03 weight percent nitrogen, a maximum of 0.002 weight percent boron, and the balance iron.

Additional features may be provided, including but not limited to the following: wherein the iron is provided in an amount of at least 95.428 weight percent; the steel alloy further comprising phosphorus in an amount not exceeding 0.03 weight percent; the steel alloy further comprising nickel in an amount not exceeding 0.25 weight percent; the steel alloy further comprising copper in an amount not exceeding 0.20 weight percent; the steel alloy further comprising titanium in an amount not exceeding 0.03 weight percent; the steel alloy further comprising nitrogen in an amount not exceeding 0.03 weight percent; and the steel alloy further comprising boron in an amount not exceeding 0.002 weight percent.

In one variation, which may be combined with or separate from other variations provided herein, the steel alloy comprises: iron, about 0.37 weight percent carbon, about 0.45 weight percent silicon, about 1.0 weight percent manganese, about 0.03 weight percent phosphorus, about 0.06 weight percent sulfur, about 1.0 weight percent chromium, about 0.1 weight percent nickel, about 0.25 weight percent molybdenum, about 0.2 weight percent copper, about 0.03 weight percent titanium, about 0.1 weight percent vanadium, about 0.03 weight percent aluminum, about 0.03 weight percent nitrogen, and about 0.0005 weight percent boron.

In another variation, which may be combined with or separate from other variations provided herein, the steel alloy consists essentially of: about 0.37 weight percent carbon, about 0.45 weight percent silicon, about 1.0 weight percent manganese, about 0.03 weight percent phosphorus, about 0.06 weight percent sulfur, about 1.0 weight percent chromium, about 0.1 weight percent nickel, about 0.25 weight percent molybdenum, about 0.2 weight percent copper, about 0.03 weight percent titanium, about 0.1 weight percent vanadium, about 0.03 weight percent aluminum, about 0.03 weight percent nitrogen, about 0.0005 weight percent boron, and the balance iron.

Further additional features may be included, including but not limited to the following: an automotive component, such as a cast automotive propulsion system component, being created from the steel alloy; and the automotive component (or the cast automotive propulsion system component) being a crankshaft, a transmission shaft, a transmission case, a differential carrier, a half shaft, or an axle shaft.

### BRIEF DESCRIPTION OF THE DRAWINGS

The drawings are provided for illustration purposes only and are not intended to limit this disclosure or the claims appended hereto.

FIG. 1 is a perspective view of a crankshaft formed of a steel alloy in accordance with the principles of the present disclosure; and

FIG. 2 is a perspective view of a transmission shaft formed of a steel alloy according to the principles of the present disclosure.

### DETAILED DESCRIPTION

Steel alloys having improved castability and low porosity are provided. These steel alloys are particularly useful for cast automotive components. In comparison to other steel alloys, these steel alloys exhibit relatively fine grain size, are easy to machine, are heat treatable, and have comparable microstructure and mechanical properties to wrought steel counterparts. The steel alloys disclosed herein are useful for forming automotive components that undergo large loads and fatigue. The automotive components may be cast, instead of forged and rolled, which saves on additional steps and costs.

As a result, the conventional quenching-tempering (QT) process can be eliminated, if desired. Elimination of the QT process can save the cost of the heat treatment of the QT procedure, as well as reducing machining due to the reduction of distortion. Instead, mere normalizing and tempering can be used to develop a complex microstructure in the steel alloys disclosed herein. In some cases, final strengths of up to 1200 MPa can be achieved.

The steel alloys disclosed herein contain iron, carbon, manganese, silicon, sulfur, chromium, molybdenum, vanadium, and aluminum, and the steel alloys may also contain phosphorus, nickel, copper, titanium, nitrogen, and boron.

The steel alloys disclosed herein may include iron and by weight about 0.34 to about 0.40 weight percent carbon; about 0.40 to about 0.60 weight percent silicon; about 0.8 to about 1.2 weight percent manganese; about 0.04 to about 0.07 weight percent sulfur; about 0.9 to about 1.2 weight percent chromium, about 0.20 to about 0.35 weight percent molybdenum; about 0.08 to about 0.15 weight percent vanadium; and about 0.02 to about 0.06 weight percent aluminum. For example, Table 1 shows a first example of the steel alloy, which contains iron, carbon, silicon, manganese, sulfur, chromium, molybdenum, vanadium, and aluminum.

TABLE 1
Example of a New Steel Alloy

| C | Si | Mn | S | Cr | Mo | V | Al |
|---|---|---|---|---|---|---|---|
| (wt %) | (wt %) | (wt %) | (wt %) | (wt %) | (wt %) | (wt %) | (wt %) |
| 0.34-0.40 | 0.40-0.60 | 0.8-1.2 | 0.04-0.07 | 0.9-1.2 | 0.20-0.35 | 0.08-0.15 | 0.02-0.06 |

In some variations, the steel alloy may also include one or more of the following: phosphorus in an amount not exceeding 0.03 weight percent; nickel in an amount not exceeding 0.25 weight percent; copper in an amount not exceeding 0.20 weight percent; titanium in an amount not exceeding 0.03 weight percent; nitrogen in an amount not exceeding 0.03 weight percent; and boron in an amount not exceeding 0.002 weight percent. The iron may be provided in an amount of at least 95 weight percent, or at least 95. 428 weight percent, by way of example. For example, Table 2 shows additional elements that may be included, by weight percent. It should be understood that the new steel alloy can have any combination of the listed elements below in Table 2, and need not include all of them.

TABLE 2
Additional elements that may be added
to the alloy shown in Table 1.

| P (wt %) | Ni (wt %) | Cu (wt %) | Ti (wt %) | N (wt %) | B (wt %) |
|---|---|---|---|---|---|
| max 0.03 | max 0.25 | max 0.20 | max 0.03 | max 0.03 | max 0.002 |

In one form, the steel alloy may contain about 0.37 weight percent carbon; about 0.45 weight percent silicon; about 1.0 weight percent manganese; about 0.03 weight percent phosphorus; about 0.06 weight percent sulfur; about 1.0 weight percent chromium; about 0.1 weight percent nickel; about 0.25 weight percent molybdenum; about 0.2 weight percent copper; about 0.03 weight percent titanium; about 0.1 weight percent vanadium; about 0.03 weight percent aluminum; about 0.03 weight percent nitrogen; about 0.0005 weight percent boron, and the balance iron. For example, this version of the steel alloy is illustrated below in Table 3.

TABLE 3
Example variation of a new steel alloy

| C | Si | Mn | P | S | Cr | Ni | Mo | Cu | Ti | V | Al | N | B |
|---|---|---|---|---|---|---|---|---|---|---|---|---|---|
| wt % | wt % | wt % | wt % | wt % | wt % | wt % | wt % | wt % | wt % | wt % | wt % | wt % | wt % |
| 0.37 | 0.45 | 1.0 | 0.03 | 0.06 | 1.0 | 0.1 | 0.25 | 0.2 | 0.03 | 0.1 | 0.03 | 0.03 | 0.0005 |

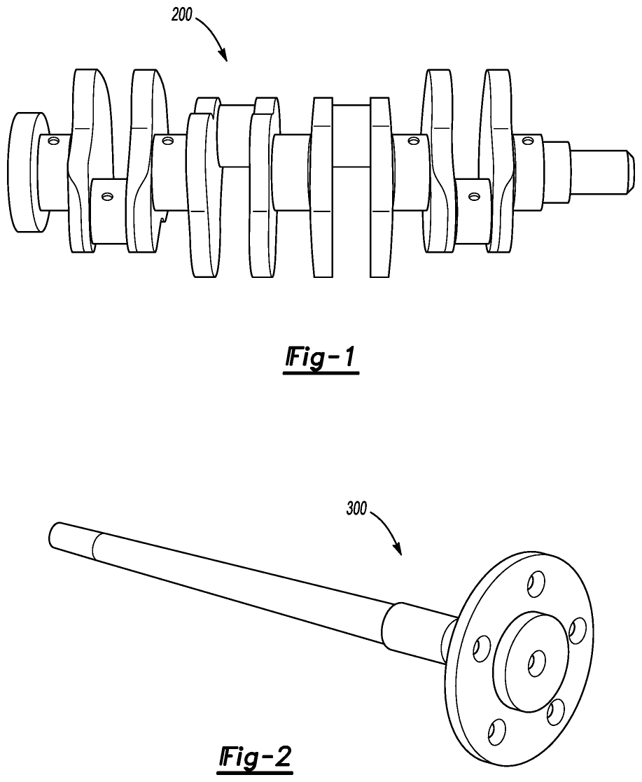

The steel alloys described herein may be used to manufacture a steel automotive component, which may be, in some cases, a cast automotive propulsion system component. Therefore, it is within the contemplation of the inventors herein that the disclosure extends to steel automotive components, including but not limited to crankshafts, transmission shafts, transmission cases, differential carriers, half shafts, axle shafts, and the like. For example, referring to FIG. 1, a crankshaft 200 is illustrated, which is made of any variation of the steel alloy described herein, and which may be cast. In FIG. 2, a transmission shaft 300 is illustrated, which is made of any variation of the steel alloy described herein, and which also may be cast.

Furthermore, while the above examples are described individually, it will be understood by one of skill in the art having the benefit of this disclosure that amounts of elements described herein may be mixed and matched from the various examples within the scope of the appended claims. It is further understood that any of the above described concepts can be used alone or in combination with any or all of the other above described concepts.

What is claimed is:

1. A steel alloy comprising:
iron;
about 0.34 to about 0.40 weight percent carbon;
about 0.40 to about 0.60 weight percent silicon;
about 0.8 to about 1.2 weight percent manganese;
about 0.04 to about 0.07 weight percent sulfur;
about 0.9 to about 1.2 weight percent chromium;
about 0.20 to about 0.35 weight percent molybdenum;
about 0.08 to about 0.15 weight percent vanadium; and
about 0.02 to about 0.06 weight percent aluminum.

2. The steel alloy of claim 1, wherein the iron is provided in an amount of at least 95 weight percent.

3. The steel alloy of claim 1, wherein the iron is provided in an amount of at least 95.428 weight percent.

4. The steel alloy of claim 3, further comprising phosphorus in an amount not exceeding 0.03 weight percent.

5. The steel alloy of claim 4, further comprising nickel in an amount not exceeding 0.25 weight percent.

6. The steel alloy of claim 5, further comprising copper in an amount not exceeding 0.20 weight percent.

7. The steel alloy of claim 6, further comprising titanium in an amount not exceeding 0.03 weight percent.

8. The steel alloy of claim 7, further comprising:
nitrogen in an amount not exceeding 0.03 weight percent; and
boron in an amount not exceeding 0.002 weight percent.

9. The steel alloy of claim 1, wherein the steel alloy comprises:
iron;
about 0.37 weight percent carbon;
about 0.45 weight percent silicon;
about 1.0 weight percent manganese;
about 0.03 weight percent phosphorus;
about 0.06 weight percent sulfur;
about 1.0 weight percent chromium;
about 0.1 weight percent nickel;
about 0.25 weight percent molybdenum;
about 0.2 weight percent copper;
about 0.03 weight percent titanium;
about 0.1 weight percent vanadium;
about 0.03 weight percent aluminum;
about 0.03 weight percent nitrogen; and
about 0.0005 weight percent boron.

10. An automotive component created from a steel alloy according to claim 8.

11. The automotive component of claim 10, wherein the automotive component is one of a crankshaft, a transmission shaft, a transmission case, a differential carrier, a half shaft, and an axle shaft.

12. A crankshaft created from a steel alloy according to claim 1.

13. A cast automotive propulsion system component formed of a steel alloy, the steel alloy comprising:
at least 95 weight percent iron;
about 0.34 to about 0.40 weight percent carbon;
about 0.40 to about 0.60 weight percent silicon;
about 0.8 to about 1.2 weight percent manganese;
about 0.04 to about 0.07 weight percent sulfur;
about 0.9 to about 1.2 weight percent chromium;
about 0.20 to about 0.35 weight percent molybdenum;
about 0.08 to about 0.15 weight percent vanadium; and
about 0.02 to about 0.06 weight percent aluminum.

14. The cast automotive propulsion system component of claim 13, further comprising:
phosphorus in an amount not exceeding 0.03 weight percent;
nickel in an amount not exceeding 0.25 weight percent;
copper in an amount not exceeding 0.20 weight percent;
titanium in an amount not exceeding 0.03 weight percent;
nitrogen in an amount not exceeding 0.03 weight percent; and
boron in an amount not exceeding 0.002 weight percent.

15. The cast automotive propulsion system component of claim 14, wherein the component is one of a crankshaft, a transmission shaft, a transmission case, a differential carrier, a half shaft, and an axle shaft.

16. The cast automotive propulsion system component of claim 13, wherein the component is a crankshaft.

17. A steel alloy consisting essentially of:
about 0.34 to about 0.40 weight percent carbon;
about 0.40 to about 0.60 weight percent silicon;
about 0.8 to about 1.2 weight percent manganese;
about 0.04 to about 0.07 weight percent sulfur;
about 0.9 to about 1.2 weight percent chromium;
about 0.20 to about 0.35 weight percent molybdenum;
about 0.08 to about 0.15 weight percent vanadium;
about 0.02 to about 0.06 weight percent aluminum;
a maximum of 0.03 weight percent phosphorus;
a maximum of 0.25 weight percent nickel;
a maximum of 0.20 weight percent copper;
a maximum of 0.03 weight percent titanium;
a maximum of 0.03 weight percent nitrogen;
a maximum of 0.002 weight percent boron; and
the balance iron.

18. The steel alloy of claim 17, wherein the steel alloy consists essentially of:
about 0.37 weight percent carbon;
about 0.45 weight percent silicon;
about 1.0 weight percent manganese;
about 0.03 weight percent phosphorus;
about 0.06 weight percent sulfur;
about 1.0 weight percent chromium;
about 0.1 weight percent nickel;
about 0.25 weight percent molybdenum;
about 0.2 weight percent copper;
about 0.03 weight percent titanium;
about 0.1 weight percent vanadium;
about 0.03 weight percent aluminum;
about 0.03 weight percent nitrogen;
about 0.0005 weight percent boron; and
the balance iron.

19. An automotive component created from a steel alloy according to claim 17.

20. The automotive component of claim 19, wherein the automotive component is one of a crankshaft, a transmission shaft, a transmission case, a differential carrier, a half shaft, and an axle shaft.
